(19) United States
(12) Patent Application Publication
(10) Pub. No.: US 2024/0071290 A1
(43) Pub. Date: Feb. 29, 2024

(54) DRIVE CIRCUIT AND DISPLAY PANEL

(71) Applicant: HKC CORPORATION LIMITED, Shenzhen (CN)

(72) Inventors: Renjie ZHOU, Shenzhen (CN); Baohong KANG, Shenzhen (CN)

(73) Assignee: HKC CORPORATION LIMITED, Shenzhen (CN)

(21) Appl. No.: 18/066,853

(22) Filed: Dec. 15, 2022

(30) Foreign Application Priority Data
Aug. 29, 2022 (CN) 202211046534.9

(51) Int. Cl. G09G 3/32

(52) U.S. Cl. CPC G09G 3/32; G09G 2300/0861; G09G 2310/0275; G09G 2320/0233; G09G 2330/021

(57) ABSTRACT

Disclosed are a drive circuit and a display panel, relates to the technical field of display. The drive circuit includes a light-emitting module, a switch module, a data drive module, a protection module and a compensation module, an output end of the switch module is connected with the light-emitting module, the switch module is accessed to a first scan signal, the switch module is for switching between an on-state and an off-state under a control of the first scan signal; and an output end of the data driver is connected with an input end of the switch module, and the data drive module is accessed to a data drive voltage and the first scan signal, the data drive module is for transporting the data drive voltage to the light-emitting module through the switch module under the control of the first scan signal.

### CROSS-REFERENCE TO RELATED APPLICATIONS

This application claims priority to the Chinese Patent Application No. 202211046534.9, filed on Aug. 29, 2022, the entire contents of which are incorporated herein by reference.

### TECHNICAL FIELD

The present disclosure relates to the technical field of display, and in particular to a drive circuit and a display panel.

### BACKGROUND

In the related art, a display panel generally provides data drive voltage to each micro light-emitting diode (LED) in the panel through data lines.

However, since the data line itself has resistance, and the lengths of the connection lines between the data line and the display panel at different positions are different, the resistances are also different, which will inevitably lead to different data drive voltages from the data lines to different positions of the display panel, and thus the color of the light emitted by the micro LED is color shifted or the brightness is uneven. Besides, the larger the display panel is, the longer the data line is. When the data line is too long, the data drive voltage will be inaccurate due to a large impedance loss, and a luminous brightness or a color will not reach the target value, which will lead to a picture quality deviation of the display panel.

### SUMMARY

The main objective of the present disclosure is to provide a drive circuit and a display panel, which aims to solve the technical problem of how to compensate the data drive voltage of the data line to avoid the picture quality deviation of the display panel.

To achieve the above objective, the present disclosure provides a drive circuit including:
a light-emitting module;
a switch module, and an output end of the switch module is connected with the light-emitting module, the switch module is accessed to a first scan signal, the switch module is for switching between an on-state and an off-state under a control of the first scan signal;
a data drive module, and an output end of the data drive module is connected with an input end of the switch module, the data drive module is accessed to a data drive voltage and the first scan signal, the data drive module is for transporting the data drive voltage to the light-emitting module through the switch module under the control of the first scan signal;
a protection module, and an output end of the protection module is connected with the data drive module, the protection module is accessed to a second scan signal, the protection module is for preventing the data drive module from outputting the data drive voltage to the light-emitting module under a control of the second scan signal; and
a compensation module, and an output end of the compensation module is connected with the output end of the data drive module and the input end of the switch module, the compensation module is accessed to a reference voltage and a third scan signal, the compensation module is for transporting the reference voltage to the data drive module under a control of the third scan signal.

In an embodiment, the light-emitting module includes a first transistor and a light-emitting device;
a gate electrode of the first transistor is connected with the output end of the switch module, a source electrode of the first transistor is connected with an anode end of the light-emitting device, a drain electrode of the first transistor is accessed to a first power supply voltage, and
a cathode end of the light-emitting device is accessed to a second power supply voltage.

In an embodiment, the light-emitting device is a micro light emitting diode, and a threshold voltage of the first transistor corresponding to the light-emitting device is compensated through the drive circuit.

In an embodiment, the first power supply voltage and the second power supply voltage is generated from an external power supply of the drive circuit, both the first power supply voltage and the second power supply voltage is for outputting a preset voltage value, and a voltage value output from the first power supply voltage is higher than a voltage value output from the second power supply voltage.

In an embodiment, the switch module includes a second transistor, and
a gate electrode of the second transistor is accessed to the first scan signal, an input end of the second transistor is electrically connected to a second node, an output end of the second transistor is connected with the gate electrode of the first transistor, and the second node is a connection point of the switch module, the data drive module and the compensation module.

In an embodiment, the data drive module includes:
a third transistor, and a gate electrode of the third transistor is accessed to the first scan signal, an input end of the third transistor is accessed to the data drive voltage, an output end of the third transistor is electrically connected to a first node, and the first node is a connection point of the data drive module and the protection module; and
a capacitor, and a first end of the capacitor is electrically connected to the first node, and a second end of the capacitor is electrically connected to the second node.

In an embodiment, the protection module includes:
a fourth transistor, a gate electrode of the fourth transistor is accessed to the second scan signal, an input end of the fourth transistor is electrically connected to the first node, and an output end of the fourth transistor is grounded.

In an embodiment, the compensation module includes:
a fifth transistor, a gate electrode of the fifth transistor is accessed to a third scan signal, an input end of the fifth transistor is accessed to the reference voltage, and an output end of the fifth transistor is electrically connected to the second node.

In an embodiment, the first scan signal, the second scan signal and the third scan signal are provided by an external sequencer through a scan line connected with the drive circuit.

In an embodiment, the first transistor, the second transistor, the third transistor, the fourth transistor and the fifth transistor are a low temperature poly-silicon thin film transistor, an oxide semiconductor thin film transistor or an amorphous silicon thin film transistor.

In an embodiment, when the first scan signal is at a low level, the second scan signal and the third scan signal are at a high level, the first transistor, the second transistor and the third transistor are turned off, and the light-emitting device is turned off to not emit light, the fourth transistor and the fifth transistor are turned on, the first node is grounded, the second node is accessed to the reference voltage, and the capacitor is charged based on the reference voltage.

In an embodiment, when the first scan signal is at a high level, the second scan signal and the third scan signal are at a low level, the first transistor, the second transistor and the third transistor are turned on, the gate electrode of the first transistor is accessed to a compensation voltage obtained by superposing the data drive signal with the reference voltage, the light-emitting device is turned on to emit light, and the fourth transistor and the fifth transistor are turned off.

In an embodiment, when the first scan signal and the third scan signal are at a low level, the second scan signal is at a high level, the first transistor, the second transistor, the third transistor and the fifth transistor are in a weak-on state, and the fourth transistor is turned on to make the light-emitting device not exhibit a weak-luminescence state.

Besides, in order to realize the above objectives, the present disclosure further provides a display panel including the drive circuit as described above.

The present disclosure provides a drive circuit and a display panel, the 5 transistors 1 capacitor (5T1C) structure is adopted by the drive circuit, and the synergy of the switch module, the data drive module, the protection module and the compensation module effectively compensates the data drive voltage received by each micro LED of the display panel, so that the data drive voltage of each micro LED can keep the same, and the luminous brightness or color can reach the target value, which avoids the picture quality deviation of the display panel, and solves the problem that since the data driver voltages from the data lines to different positions of the display panel are different, when each micro LED of the display panel emits light, the color is deviated or the brightness is uneven.

### BRIEF DESCRIPTION OF THE DRAWINGS

In order to more clearly illustrate the technical solutions in the embodiments of the present disclosure or in the related art, drawings used in the embodiments or in the related art will be briefly described below. Obviously, the drawings in the following description are only some embodiments of the present disclosure. It will be apparent to those skilled in the art that other figures can be obtained according to the structures shown in the drawings without creative work.

FIG. 1 is a schematic diagram of function modules of a drive circuit according to an embodiment of the present disclosure.

FIG. 2 is a schematic structural view of a drive circuit according to an embodiment of the present disclosure.

FIG. 3 is a schematic partition view of the display panel of the drive circuit according to an embodiment of the present disclosure.

FIG. 4 is a schematic structural diagram of the display panel according to the embodiments of the present disclosure.

The realization of the objective, functional characteristics, and advantages of the present disclosure are further described with reference to the accompanying drawings.

### DETAILED DESCRIPTION OF THE EMBODIMENTS

It should be understood that the specific embodiments described herein are only used to explain the present disclosure, and are not intended to limit the present disclosure.

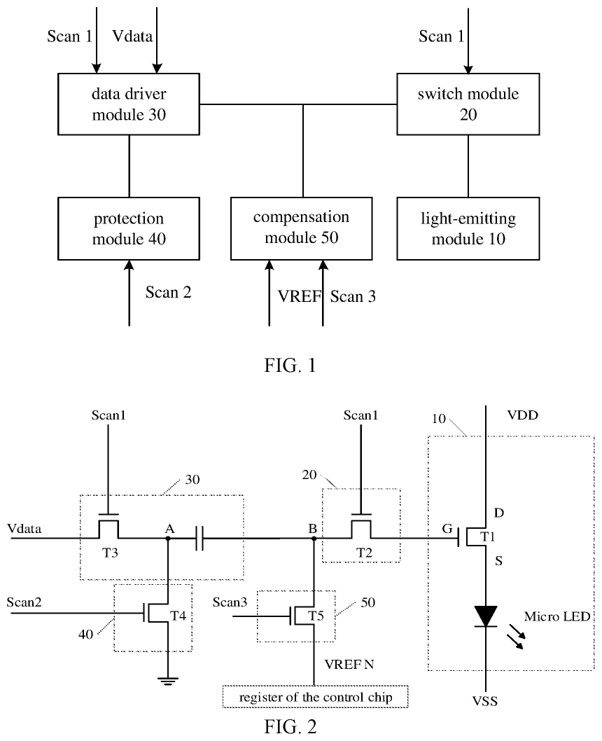

The present disclosure provides a drive circuit, as shown in FIG. 1, which is a schematic diagram of function modules of a drive circuit according to an embodiment of the present disclosure.

In an embodiment, the drive circuit includes a light-emitting module 10, a switch module 20, a data drive module 30, a protection module 40 and a compensation module 50.

An output end of the switch module 20 is connected with the light-emitting module 10, the switch module 20 is accessed to a first scan signal Scan1, and the switch module 20 is for switching between an on-state and an off-state under a control of the first scan signal Scan1.

An output end of the data driver is connected with an input end of the switch module 20, and the data drive module 30 is accessed to a data drive voltage Vdata and the first scan signal Scan1, the data drive module 30 is for transporting the data drive voltage Vdata to the light-emitting module 10 through the switch module 20 under the control of the first scan signal Scan1.

An output end of the protection module 40 is connected with the data drive module 30, the protection module 40 is accessed to a second scan signal Scan2, the protection module 40 is for preventing the data drive module 30 from outputting the data drive voltage Vdata to the light-emitting module 10 under the control of the second scan signal Scan2.

An output end of the compensation module 50 is connected with the output end of the data drive module 30 and the input end of the switch module 20, the compensation module 50 is accessed to a reference voltage VREF and a third scan signal Scan3, the compensation module 50 is for transporting the reference voltage VREF to the data drive module 30 under a control of the third scan signal Scan3.

The drive circuit of the present disclosure is provided based on a quantity of the micro LED of the display panel, i.e., each micro LED is corresponded with the drive circuit, and the data drive voltage Vdata is originated from the data line, the reference voltage VREF is originated from a register of a control chip.

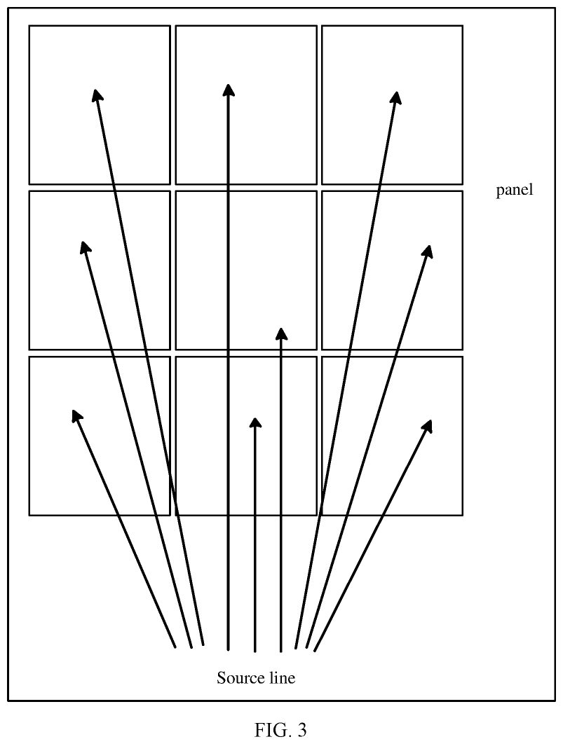

Further, as shown in FIG. 2, which is a schematic structural view of a drive circuit according to an embodiment of the present disclosure.

It should be noted that, the transistor adopted by all embodiments of the present disclosure can be a thin film transistor (TFT), a field effect transistor or other devices that have the same features, since a source electrode of the transistor and a drain electrode of the transistor are symmetrical, the source electrode and the drain electrode can be replaced with each other. In embodiments of the present disclosure, in order to distinguish two electrodes of the transistor except the gate electrode, one electrode is called the source electrode, and the other electrode is called the drain electrode, and since the transistor adopted by this embodiment may include a P-type transistor and/or a N-type transistor, where the P-type transistor is turned on when the gate electrode is at the low level and the P-type transistor is turned off when the gate electrode is at the high level, and the N-type transistor is turned on when the gate electrode is at the high level and the N-type transistor is turned off when the gate electrode is at the low level. The source electrode and the drain electrode of the P-type transistor and the N-type transistor are opposite. Therefore, in this embodiment, the two electrodes of each transistor except the gate electrode are named as the input terminal and the output terminal, and specifically, naming a corresponding terminal of the source electrode and the drain electrode respectively depends on the P-type or the N-type that the transistor is. As shown in FIG. 2, the port characteristics of the first transistor T1, T1 can be determined according to the G, D, and S labels in the figure, the G is the gate electrode of T1, the S is the source electrode of T1, the D is the drain electrode of T1, and the rest transistors can be specified according to the initial stage of signal generation: the middle terminal of each transistor is the gate electrode, the signal input terminal is the source electrode or the drain electrode, and the signal output terminal is the drain electrode or the source electrode corresponding to the signal input terminal.

As shown in FIG. 2, in the embodiments, the light-emitting module 10 includes a first transistor T1, and a light-emitting device Micro LED.

A gate electrode G of the first transistor T1 is connected with the output end of the switch module 20, a source electrode S of the first transistor T1 is connected with an anode end of the light-emitting device Micro LED, a drain electrode D of the first transistor T1 is accessed to a first power supply voltage VDD.

A cathode end of the light-emitting device Micro LED is accessed to a second power supply voltage VSS.

In some embodiments, the light-emitting device Micro LED can be a micro light emitting diode, i. e. in the embodiments of the present disclosure, and a threshold voltage of the first transistor T1 corresponding to each light-emitting device Micro LED of the display panel is compensated through the drive circuit, and the drive circuit is of 5T1C structure, so that the less components are used, and the structure is simple and stable, the cost is saved.

In some embodiments, the first power supply voltage VDD and the second power supply voltage VSS is generated from an external power supply of the drive circuit, both the first power supply voltage VDD and the second power supply voltage VSS is for outputting a preset voltage value, and a voltage value output from the first power supply voltage VDD is higher than a voltage value output from the second power supply voltage VSS.

Further, in an embodiment, the switch module 20 includes a second transistor T2.

A gate electrode of the second transistor T2 is accessed to the first scan signal Scan1, an output end of the second transistor T2 is electrically connected to a second node B, an input end of the second transistor T2 is connected with the gate electrode G of the first transistor T1, and the second node B is a connection point of the switch module 20, the data drive module 30 and the compensation module 50.

Further, in an embodiment, the data drive module 30 includes a third transistor T3 and a capacitor C.

A gate electrode of the third transistor T3 is accessed to the first scan signal Scan1, an input end of the third transistor T3 is accessed to the data drive voltage Vdata, an output end of the third transistor T3 is electrically connected to a first node A; and the first node A is a connection point of the data drive module 30 and the protection module 40.

A first end of the capacitor C is electrically connected to the first node A, and a second end of the capacitor C is electrically connected to the second node B.

Further, in an embodiment, the protection module 40 includes a fourth transistor T4.

A gate electrode of the fourth transistor T4 is accessed to the second scan signal Scan2, and an input end of the fourth transistor T4 is electrically connected to the first node A, an output end of the fourth transistor T4 is grounded.

Further, in an embodiment, the compensation module 50 includes a fifth transistor T5.

A gate electrode of the fifth transistor T5 is accessed to a third scan signal Scan3, an input end of the fifth transistor T5 is accessed to the reference voltage VREF, and an output end of the fifth transistor T5 is electrically connected to the second node B.

Further, in an embodiment, the first scan signal Scan1, the second scan signal Scan2 and the third scan signal Scan3 are provided by an external sequencer through a scan line connected with the drive circuit.

Further, in an embodiment, the first transistor T1, the second transistor T2, the third transistor T3, the fourth transistor T4 and the fifth transistor T5 can be a low temperature poly-silicon thin film transistor, an oxide semiconductor thin film transistor or an amorphous silicon thin film transistor. The transistors of the drive circuit in the embodiments of the present disclosure are transistors made of one same material, so that the effect of the difference between the transistors made of different materials is avoided.

Further, in an embodiment, when the first scan signal Scan1 is at a low level, the second scan signal Scan2 and the third scan signal Scan3 are at a high level, the first transistor T1, the second transistor T2 and the third transistor T3 are turned off, and the light-emitting device Micro LED is turned off to not emit light, the fourth transistor T4 and the fifth transistor T5 are turned on, the first node A is grounded, the second node B is accessed to the reference voltage VREF, and the capacitor C is charged based on the reference voltage VREF.

It should be noted that, when the first scan signal Scan1 is at a low level, the second scan signal Scan2 and the third scan signal Scan3 are at a high level, the first transistor T1, the second transistor T2 and the third transistor T3 are turned off, the fourth transistor T4 and the fifth transistor T5 are turned on, then the second node B is accessed to the reference voltage VREF to charge the capacitor C, and the reference voltage VREF written into different areas of the display panel are different.

Further, in an embodiment, when the first scan signal Scan1 is at a high level, the second scan signal Scan2 and the third scan signal Scan3 are at a low level, the first transistor T1, the second transistor T2 and the third transistor T3 are turned on, the gate electrode G of the first transistor T1 is accessed to a compensation voltage obtained by superposing the data drive signal with the reference voltage VREF, the light-emitting device Micro LED is turned on to emit light, and the fourth transistor T4 and the fifth transistor T5 are turned off.

It should be noted that, when the first scan signal Scan1 is at a high level, the second scan signal Scan2 and the third scan signal Scan3 are at a low level, the second transistor T2 and the third transistor T3 are turned on, the fourth transistor T4 and the fifth transistor T5 are turned off, then the G point of the first transistor T1 can obtain a voltage: Vg=Vdata+VREF, and the first transistor T1 is turned on so that the light-emitting device Micro LED is turned on and emits light.

Further, in an embodiment, when the first scan signal Scan1 and the third scan signal Scan3 are at a low level, the second scan signal Scan2 is at a high level, the first transistor T1, the second transistor T2, the third transistor T3 and the fifth transistor T5 are in a weak-on state, the fourth transistor T4 is turned on to make the light-emitting device Micro LED not exhibit a weak-luminescence state.

It should be noted that, when the display panel is working in a high temperature, the threshold voltage of the TFT will be lowered, then all the TFT might be in the weak on-state, the voltage from the data line Vdata may reach the TFT which drives the display panel to emit light, i. e. the G point of the first transistor T1 in the figure, then the first transistor T1 may be in the weak on-state, the current of the first power supply voltage VDD may be accessed to the micro LED so that the micro LED is in the weak-luminescence state. However, in this embodiment, in the condition of providing the capacitor C and the fourth transistor T4, the second scan signal Scan2 is adjusted as the high level, thus the first transistor T1 and the third transistor T3 is separated, so that a direct current composition of the data drive voltage Vdata cannot be accessed to the G point of the first transistor T1, which avoid the weak-luminescence state of the micro LED.

It should be understood that, if a display panel is divided into N areas, as shown in FIG. 3, where the display panel is divided into 9 areas, so that the lengths from the Source lines (data line) to each areas are different, the impedance is different, and the larger the display panel is, the more differences of the impedance of the data lines are, so that the color of the display panel is deviated and the brightness is uneven, thus the embodiment provides a drive circuit, by adding a precharged voltage VREF N (the N is an area code), thus solves the problem that the voltage is different since the data line impedance of the display panel is different, in an actual condition, voltages of each area of the reference voltage VREF N can be manually adjusted by controlling a chip register, so a bad compensation condition that a theoretical value is different from an actual technology is avoided. The more areas the display panel is divided into, the more ideal the adjustment effect is, and the reference voltage VREF N needs to be adjusted only once when the display panel is produced, then the impedance of each areas of the data line is determined, the impedance value difference between each areas is also determined, so that a very complicated control circuit is not needed in the embodiments to change the reference voltage VREF value of each data line in the display panel.

Besides, a substitute solution can be provided on the basis of the embodiments, such as a subarea compensation solution that the reference voltage VREF is added on all data of the driver, though the structure of the display panel of this solution is simple, as for the driver, the solution add a voltage on the data output by the driver, the input of the driver cannot be increased, which is due to the few input pins and the much output pins of the driver, and a series of transforms is needed from the input to the output to reach the objective, the debugging is complicated, and a design of the driver is difficult and the cost is expensive. In comparison to the substitute solution, the solution provided in the embodiments is a preferred solution, in the embodiments, the data drive voltage Vdata and the voltage compensated by the reference voltage VREF is separated, and the reference voltage VREF can be directly connected from the input of the driver to the output of the driver without a series of transforms, and the reference voltage VREF can be adjusted flexibly, and compared to the prior art, the embodiments have the characteristics of easy implementation and low cost.

The driving circuit provided in this embodiment overcomes the technical problem in the prior art that due to the data drive voltages Vdata from the data lines to different positions of the display panel are different, resulting in the phenomenon of color deviation or uneven brightness when each micro LED in the display panel emits light. The drive circuit adopts 5T1C structure, based on the synergy of the switch module 20, the data drive module 30, the protection module 40 and the compensation module 50, which effectively compensates the data drive voltage Vdata received by each micro LED in the display panel, so that each micro LED in the display panel can keep the same, and the luminous brightness or color can reach the target value, which avoids the phenomenon of picture quality deviation of the display panel.

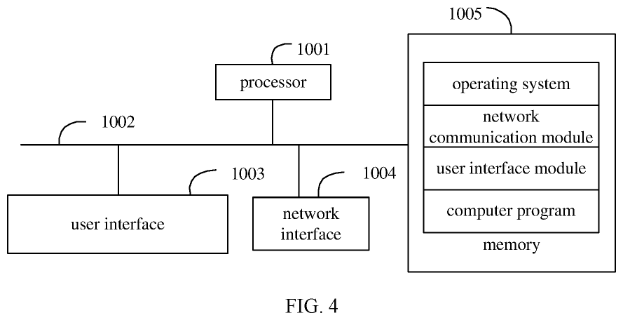

Besides, a display panel is further provided in the embodiments, the display panel includes the above drive circuit, as shown in FIG. 4, which is a schematic structural diagram of the display panel according to the embodiments of the present disclosure.

As shown in FIG. 4, the display panel further includes: a processor, such as a central processing unit (CPU), a main communication line, a user interface, a network interface, a memory. The main communication line is for a connection and a communication of components. The user interface can include a display, an input unit such as a keyboard, and in an embodiment, the user interface can further include a standard wired interface and a standard wireless interface. In an embodiment, the network interface includes a standard wired interface and a standard wireless interface (such as a wireless-fidelity (WIFI) interface). The memory can be a high speed random access memory (RAM), and can also be a stable non-volatile memory (NVM), such as a magnetic disk memory. In other embodiments, the memory may further be a storage device independent of the processor.

It is understandable for those skilled in the art that the structure shown in FIG. 4 is not limited to the display panel, and may include more or less components than the one shown, or a combination of some components, or different arrangement of the components.

As shown in FIG. 4, the memory as a storage medium may include an operating system, a data storage module, a network communication module, a user interface module; and a computer program.

In the display panel shown in FIG. 4, the network interface is mainly for a data communication with other devices, and the user interface is mainly for a data interaction with the user, and the processor and the memory of the embodiments are provided in the display panel, the computer program stored in the memory is invoked and the drive circuit is controlled by the display panel through the processor.

For each embodiment of the display panel of the present disclosure, reference may be made to each embodiment of the drive circuit of the present disclosure, and details are not repeated herein.

It should be noted that, the terms “including”, “including” or any other variation thereof are intended to encompass non-exclusive inclusion, such that a process, method, object or system including a series of elements includes not only those elements, it also includes other elements not expressly listed or inherent to such a process, method, object or system. Without further limitation, an element qualified by the phrase “including a . . . ” does not preclude the presence of additional identical elements in the process, method, object or system that includes the element.

The above-mentioned serial numbers of the embodiments of the present disclosure are only for description, and do not represent the advantages or disadvantages of the embodiments.

From the description of the above embodiments, those skilled in the art can clearly understand that the method of the above embodiment can be implemented by means of software plus a necessary general hardware platform, and of course can also be implemented by hardware, but in many cases the former is better implementation. Based on such understanding, the technical solutions of the present disclosure can be embodied in the form of software products in essence or the parts that make contributions to the prior art, and the computer software products are stored in a storage medium as described above, (such as a read only memory (ROM)/RAM), a magnetic disk, an optical disk), including several instructions to make a terminal device (which may be a mobile phone, a computer, a server, an air conditioner, or a network device, etc.) execute the methods described in each embodiment of the present disclosure.

The above are only some embodiments of the present disclosure, and do not limit the scope of the present disclosure thereto. Under the inventive concept of the present disclosure, equivalent structural transformations made according to the description and drawings of the present disclosure, or direct/indirect application in other related technical fields are included in the scope of the present disclosure.

1. A drive circuit, comprising:
a light-emitting module;
a switch module, wherein an output end of the switch module is connected with the light-emitting module, the switch module is accessed to a first scan signal, the switch module is for switching between an on-state and an off-state under a control of the first scan signal;
a data drive module, wherein an output end of the data drive module is connected with an input end of the switch module, the data drive module is accessed to a data drive voltage and the first scan signal, the data drive module is for transporting the data drive voltage to the light-emitting module through the switch module under the control of the first scan signal;
a protection module, wherein an output end of the protection module is connected with the data drive module, the protection module is accessed to a second scan signal, the protection module is for preventing the data drive module from outputting the data drive voltage to the light-emitting module under a control of the second scan signal; and
a compensation module, wherein an output end of the compensation module is connected with the output end of the data drive module and the input end of the switch module, the compensation module is accessed to a reference voltage and a third scan signal, the compensation module is for transporting the reference voltage to the data drive module under a control of the third scan signal,
wherein the reference voltage is adjustable according to the data drive voltage of the data drive module.

2. The drive circuit of claim 1, wherein:
the light-emitting module comprises a first transistor and a light-emitting device,
a gate electrode of the first transistor is connected with the output end of the switch module, a source electrode of the first transistor is connected with an anode end of the light-emitting device, a drain electrode of the first transistor is accessed to a first power supply voltage, and
a cathode end of the light-emitting device is accessed to a second power supply voltage.

3. The drive circuit of claim 2, wherein the light-emitting device is a micro light-emitting diode, and a threshold voltage of the first transistor corresponding to the light-emitting device is compensated through the drive circuit.

4. The drive circuit of claim 2, wherein the first power supply voltage and the second power supply voltage are generated from an external power supply of the drive circuit, both the first power supply voltage and the second power supply voltage are for outputting a preset voltage value, and a voltage value output from the first power supply voltage is higher than a voltage value output from the second power supply voltage.

5. The drive circuit of claim 2, wherein:
the switch module comprises a second transistor, and
a gate electrode of the second transistor is accessed to the first scan signal, an input end of the second transistor is electrically connected to a second node, an output end of the second transistor is connected with the gate electrode of the first transistor, and the second node is a connection point of the switch module, the data drive module and the compensation module.

6. The drive circuit of claim 5, wherein the data drive module comprises:
a third transistor, wherein a gate electrode of the third transistor is accessed to the first scan signal, an input end of the third transistor is accessed to the data drive voltage, an output end of the third transistor is electrically connected to a first node, and the first node is a connection point of the data drive module and the protection module.

7. The drive circuit of claim 6, wherein the data drive module further comprises:
a capacitor, wherein a first end of the capacitor is electrically connected to the first node, and a second end of the capacitor is electrically connected to the second node.

8. The drive circuit of claim 7, wherein the protection module comprises a fourth transistor, a gate electrode of the fourth transistor is accessed to the second scan signal, an input end of the fourth transistor is electrically connected to the first node, and an output end of the fourth transistor is grounded.

9. The drive circuit of claim 8, wherein the compensation module comprises a fifth transistor, a gate electrode of the fifth transistor is accessed to a third scan signal, an input end of the fifth transistor is accessed to the reference voltage, and an output end of the fifth transistor is electrically connected to the second node.

10. The drive circuit of claim 9, wherein the first scan signal, the second scan signal and the third scan signal are provided by an external sequencer through a scan line connected with the drive circuit.

11. The drive circuit of claim 9, wherein the first transistor, the second transistor, the third transistor, the fourth transistor and the fifth transistor are low temperature poly-silicon thin film transistors, oxide semiconductor thin film transistors or amorphous silicon thin film transistors.

12. The drive circuit of claim 9, wherein when the first scan signal is at a low level, the second scan signal and the third scan signal are at a high level, the first transistor, the second transistor and the third transistor are turned off, and the light-emitting device is turned off to not emit light, the fourth transistor and the fifth transistor are turned on, the first node is grounded, the second node is accessed to the reference voltage, and the capacitor is charged based on the reference voltage.

13. The drive circuit of claim 12, wherein when the first scan signal is at a high level, the second scan signal and the third scan signal are at a low level, the first transistor, the second transistor and the third transistor are turned on, the gate electrode of the first transistor is accessed to a compensation voltage obtained by superposing the data drive signal with the reference voltage, the light-emitting device is turned on to emit light, and the fourth transistor and the fifth transistor are turned off.

14. The drive circuit of claim 13, wherein when the first scan signal and the third scan signal are at a low level, the second scan signal is at a high level, the first transistor, the second transistor, the third transistor and the fifth transistor are in a weak-on state, and the fourth transistor is turned on to make the light-emitting device not exhibit a weak-luminescence state.

15. A display panel, comprising:
a drive circuit, wherein the drive circuit comprises:
a light-emitting module;
a switch module, wherein an output end of the switch module is connected with the light-emitting module, the switch module is accessed to a first scan signal, the switch module is for switching between an on-state and an off-state under a control of the first scan signal;
a data drive module, wherein an output end of the data drive module is connected with an input end of the switch module, the data drive module is accessed to a data drive voltage and the first scan signal, the data drive module is for transporting the data drive voltage to the light-emitting module through the switch module under the control of the first scan signal;
a protection module, wherein an output end of the protection module is connected with the data drive module, the protection module is accessed to a second scan signal, the protection module is for preventing the data drive module from outputting the data drive voltage to the light-emitting module under a control of the second scan signal; and
a compensation module, wherein an output end of the compensation module is connected with the output end of the data drive module and the input end of the switch module, the compensation module is accessed to a reference voltage and a third scan signal, the compensation module is for transporting the reference voltage to the data drive module under a control of the third scan signal,
wherein the reference voltage is adjustable according to the data drive voltage of the data drive module.
